(19) United States
(12) Patent Application Publication
(10) Pub. No.: US 2007/0284514 A1
(43) Pub. Date: Dec. 13, 2007

(54) INPUT DEVICE

(75) Inventors: Wei-Chan Sung, Taichung City (TW); Liang-Yu Yao, Taipei County (TW)

Correspondence Address: QUINTERO LAW OFFICE, PC, 2210 MAIN STREET, SUITE 200, SANTA MONICA, CA, 90405, US

(73) Assignee: DARFON ELECTRONICS CORP., TAOYUAN (TW)

(21) Appl. No.: 11/757,969

(22) Filed: Jun. 4, 2007

(30) Foreign Application Priority Data
Jun. 7, 2006 (TW) TW95120166

(51) Int. Cl. G09G 5/08; G06F 3/033

(52) U.S. Cl. 250/221; 345/166

(57) ABSTRACT

An input device comprises a circuit board, an optical sensor, an optical lens and a light generator. The circuit board has a through hole. The optical lens is disposed between the circuit board and the optical sensor. The light generator emits a light beam which passes through the through hole and projects onto a plane, which is then reflected to the optical lens. The optical sensor captures the light beam passed through the optical lens.

### BACKGROUND OF THE INVENTION

1. Field of the Invention

The invention provides an input device, and in particular, to an input device with an optical lens disposed between an optical sensor and a circuit board, enhancing positioning of the optical lens.

2. Description of the Related Art

Referring to FIG. 1, a conventional input device, such as an optical mouse 1, comprises a cover 2, an optical lens 3, a circuit board 4, an optical sensor 5 and light generator 6. The cover has an aperture 2a. The optical lens 3, disposed on the cover 2 above the aperture 2a, comprises a lens 3a corresponding to the aperture 2a. The circuit board 4, disposed on the optical lens 3, comprises a through hole 4a above the optical lens 3. The optical sensor 5 is disposed above the through hole 4a of the circuit board 4, receiving and analyzing images beneath the optical mouse 1. The light generator 6 provides a light source to the optical sensor 5. The light generator 6 emits a light beam on a table or a mouse pad, and the optical sensor 5 captures the reflected light beam to determine an uneven or rough surface in order to control the operation of the optical mouse 1.

In the embodiment however, due to disposition of the optical lens 3 on the cover 2, the design of the cover 2 easily affects the positioning and leveling of the optical lens 3. If a portion of reflected light is not able to enter the lens 3a due to flawed disposition of the optical lens 3 on the cover 2, misinterpretation of the reflected light entering the optical sensor 5 will result.

### BRIEF SUMMARY OF THE INVENTION

The invention provides an input device with an optical lens disposed between the circuit board and the optical sensor for positioning the optical lens.

The input device comprises a circuit board, an optical sensor, an optical lens and a light generator. The circuit board has a through hole. The optical lens is disposed between the circuit board and the optical sensor. The light generator emits a light beam which passes through the through hole and projects onto a plane, which is then reflected to the optical lens. The optical sensor captures the light beam passed through the optical lens.

The optical lens has an aperture and the optical sensor has a protrusion engaging the aperture, positioning the optical sensor and the optical lens.

The optical lens comprises a lens disposed under the aperture, allowing the light beam to be condensed and to form an image on the optical sensor.

The optical sensor comprises a plurality of pins electrically connecting to the circuit board.

The circuit board comprises a plurality of notches, allowing the pins of the optical sensor to insert and weld to the circuit board.

The optical lens further comprises a base where the light generator is disposed.

The input device further comprises a housing receiving the circuit board, the optical sensor, the optical lens and the light generator.

The housing comprises an opening, allowing the light beam to pass therethrough to the plane and to be reflected.

The input device comprises a mouse and the light generator is a light emitting diode or a laser diode.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of a conventional optical mouse;

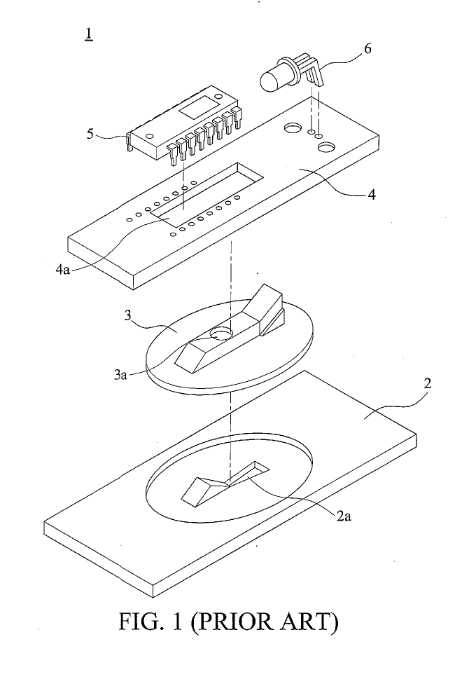

FIG. 2 is an exploded view of an optical mouse of the invention;

FIG. 3 is a sectional view along line A-A of the optical mouse in FIG. 2;

FIG. 4 is a schematic view of the optical mouse of the invention; and

FIG. 5 is a sectional view along line A-A of the optical mouse in FIG. 4.

### DETAILED DESCRIPTION OF THE INVENTION

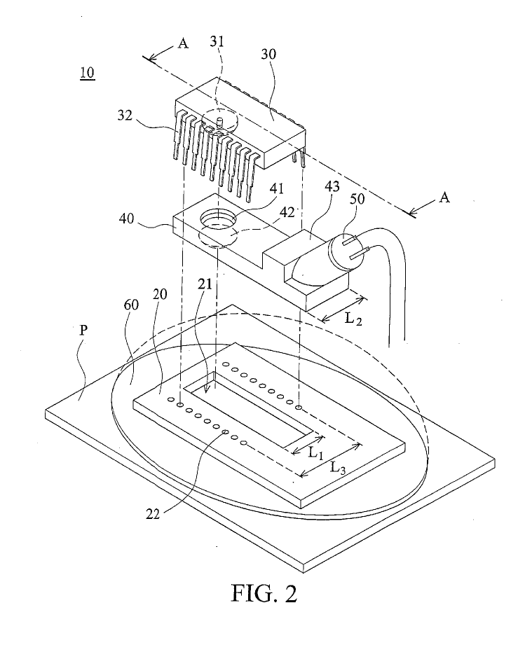

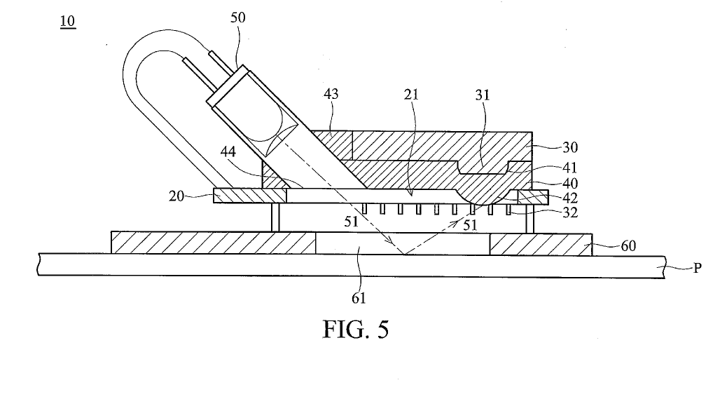

Referring to FIG. 2, the input device of the invention is an optical mouse 10. The optical mouse 10, placed on a plane P, comprises a circuit board 20, an optical sensor 30, an optical lens 40, a light generator 50 and a housing 60. The circuit board 20 has a through hole 21. The optical sensor 30, the optical lens 40 and the light generator 50 are disposed on the circuit board 20, and the optical lens 40 is disposed between the circuit board 20 and the optical sensor 30. The light generator 50 emits a light beam 51, as shown in FIG. 5. The light beam 51 passes through the through hole 21 to the plane P, and is reflected to the optical lens 40. The light beam 51 passes through the optical lens 40 and is received by the optical sensor 30. The housing 60 receives the circuit board 20, the optical sensor 30, the optical lens 40 and the light generator 50.

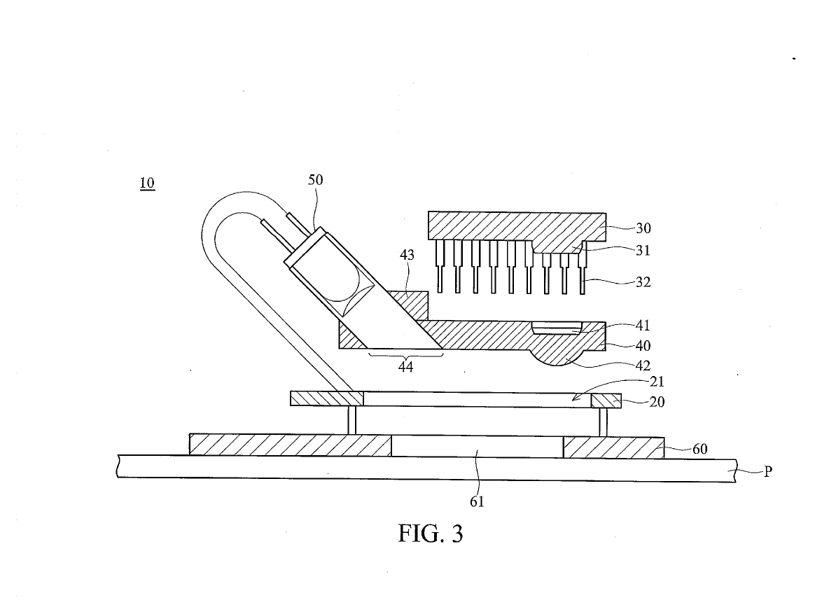

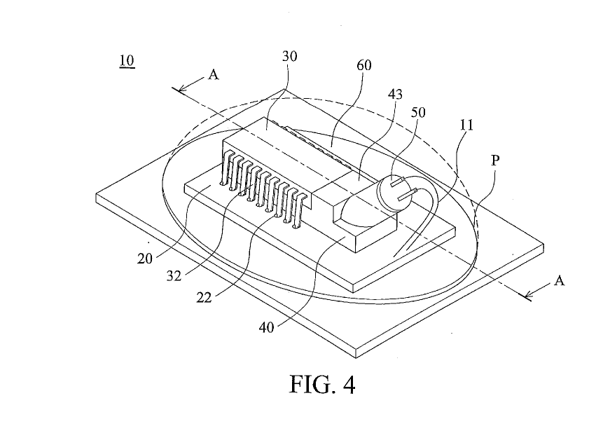

Referring to FIG. 3, the housing 60 comprises a first opening 61. The circuit board 20 is disposed on the housing 60, wherein the through hole 21 of the circuit board 20 corresponds to the first opening 61. Additionally, the circuit board 20 has a plurality of recesses 22, as shown in FIG. 4, disposed on two sides of the through hole 21. As shown in FIG. 4, there are nine recesses 22 on each side in a line, and the optical lens 40 is disposed between the two lines of the recesses 22.

Referring to FIG. 3, the optical lens 40 further comprises an aperture 41, a lens 42 and a base 43. The lens 42 is disposed under the aperture 42 and received in the through hole 21, allowing the reflected light beam 1 to directly enter the lens 42. The base 43, supporting and positioning the light generator 50, comprises a second opening 44 under the base 43, providing a passage for the light beam 51, as shown in FIG. 5, to pass therethrough.

The optical sensor 30 comprises a protrusion 31 and a plurality of pins 32. The protrusion 31 corresponds to the aperture 41 of the optical lens 40, and the plurality of pins 32, located on two sides of the optical sensor 30, correspond to the two lines of the recesses 22, as shown in FIG. 4. When the protrusion 31 engages with the aperture 41, the pins 32 are inserted and welded in the corresponding recesses 22, as shown in FIG. 4, allowing the optical sensor 30 to electrically connect with the circuit board 20. A sectional view of the optical mouse showing the assembled components is shown in FIG. 5.

Referring to FIG. 2, the width L₁ of the through hole 21 on the circuit board 20 is less than the width L₂ of the optical lens 40, but the width L₁ of the through hole 21 is greater than the width of the lens 42, such that the lens 42 is able to be contained in the through hole 21 (as shown in FIG. 5). The distance L₃ between two lines of the recesses 22 is slightly greater than width L₂ of the optical lens 40, such that the optical lens 40 is limited to the two lines of the recesses 22, and correspondingly the optical lens 40 can be positioned precisely.

Referring to FIG. 4, when the components are assembled, the optical sensor 30, the optical lens 40 and the circuit board 20 are parallel to each other. Referring to FIG. 5, when the optical mouse 10 is in operation, the light beam 51 of the light generator 50 passes through the through hole 21 and then the first opening 61, before reaching the plane P. The light beam 51 is then reflected to the lens 42 and received by the optical sensor 30. By analyzing the reflected light beam, the optical sensor 30 is able to determine the unevenness or the roughness of the plane P, and control the operation of the optical mouse 10. Unlike the conventional design, the optical lens 40 is not disposed on the cover 60; therefore, the positioning and the leveling of the optical lens 40 is not easily affected by a flawed design in the cover 60. In this embodiment, manufacturing assembly defects can be minimized by a more secure connection and support between the optical sensor 30 and the optical lens 40, thus lowering manufacturing assembly costs and enhancing yields.

It should be noted that the curved dotted line in FIG. 2 and FIG. 4 represents the contour of the optical mouse 10. All components are disposed in the optical mouse 10.

Referring to FIG. 2, the size and location of the through hole 21 is not fixed. The size of the through hole 21 can be reduced. The through hole 21 can also be disposed on the path of the light beam 51.

The number of the recesses 22 is not fixed as shown in FIGS. 2 and 4. The number of the recesses 22 can be varied as long as they correspond to the number of pins.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An input device, comprising
a circuit board having a through hole;
an optical sensor;
an optical lens disposed between the circuit board and the optical sensor; and
a light generator emitting a light beam;
wherein the light beam passes through the through hole, projecting onto a plane and reflecting to the optical lens, and the optical sensor receives the light beam passed through the optical lens.

2. The input device as claimed in claim 1, wherein the optical lens has an aperture and the optical sensor has a protrusion engaging the aperture, positioning the optical sensor and the optical lens.

3. The input device as claimed in claim 2, wherein the optical lens comprises a lens disposed under the aperture, allowing the light beam to be condensed and to form an image on the optical sensor.

4. The input device as claimed in claim 1, wherein the optical sensor comprises a plurality of pins electrically connected to the circuit board.

5. The input device as claimed in claim 4, wherein the circuit board comprises a plurality of recesses, allowing the pins of the optical sensor to insert and weld to the circuit board.

6. The input device as claimed in claim 1, wherein the optical lens further comprises a base receiving the light generator.

7. The input device as claimed in claim 1, further comprising a housing receiving the circuit board, the optical sensor, the optical lens and the light generator.

8. The input device as claimed in claim 7, wherein the housing comprises an opening, allowing the light beam to pass therethrough to the plane and to be reflected.

9. The input device as claimed in claim 1, wherein the input device comprises a mouse.

10. The input device as claimed in claim 1, wherein the light generator is a light emitting diode.

11. The input device as claimed in claim 1, wherein the light generator is a Laser diode.
